(19) United States
(12) Patent Application Publication
(10) Pub. No.: US 2022/0222619 A1
(43) Pub. Date: Jul. 14, 2022

(54) DETECTING EVENTS OF INTEREST FOR ECOMMERCE SHIPMENTS BASED ON NETWORK CONDITIONS

(71) Applicant: ALPERTON LTD., Tel Aviv (IL)

(72) Inventors: Ofer LAVI, Herzliya (IL); Yigal JACK, Bridgend (GB); Tamir AVRAMOV, Haifa (IL); Omer COLE, Nesher (IL); Assi ROTBART, Tel Aviv (IL)

(21) Appl. No.: 17/607,451

(22) PCT Filed: Apr. 28, 2020
(86) PCT No.: PCT/RU2020/050086

§ 371 Date: Oct. 29, 2021

Related U.S. Application Data
(60) Provisional application No. 62/840,424, filed on Apr. 30, 2019.

(51) Int. Cl. G06Q 10/08

(52) U.S. Cl. CPC G06Q 10/0833

(57) ABSTRACT

Information about a network condition of a remote device coupled to an ecommerce shipment is received. An event of interest is detected based on the networking condition, and, optionally, the ecommerce shipping information of the shipment to which the remote device is coupled, and the event of interest is provided to the customer, merchant, and ecommerce platform.

### TECHNICAL FIELD

This document generally relates to ecommerce shipment tracking.

### BACKGROUND

Ecommerce platforms allow merchants to reach a wide range of customers through the Internet. The purchasing process on these platforms is carefully designed so as to keep the customer engaged and ensure a sale goes through successfully. However, from the time the product is purchased and until it is delivered the merchant is no longer in direct contact with the customer and at the same time the customer is in the dark with regards to the actual shipment status. Unlike most standard cargo shipments, each ecommerce shipment is highly valued by its customer as it is a unique and one-time purchase. It is therefore crucial for ecommerce merchants to provide their customers with the best possible service, for example by informing the customer, in advance, of potential issues or delays with their shipment.

Keeping the customer informed of events of interest in the delivery process may be achieved by various techniques. In one example, an initial determination is made to identify the current location of the purchased product. The determination may be made, for example, by triangulating the shipment's current location based on the cellular or wireless networks visible to a tracking device coupled with the ecommerce shipment and looking up the networks' base stations locations. The location may then be considered by the system for display to the customer and may also be used to determine whether an event of interest should be provided to the customer. For example, the customer can be informed of an event of interest when the product has been shipped once the system determines, based on the identified location, that the shipment has moved away from its previously identified initial location.

In another example, a determination is made to identify the transport the shipment is loaded on. The determination may be made, for example, by tracking the signal level of the transport's on-board wifi over a predetermined distance as it is recorded by a tracking device coupled with the ecommerce shipment. The determined transport is then compared to the shipment's planned transport, for example, by identifying a marine vessel the shipment is loaded onto based on the shipment's bill of lading. This information can be used to determine whether an event of interest should be provided to the customer. For example, the customer can be informed of an event of interest when the shipment is loaded on the correct vessel, and likewise, when the shipment is loaded on an incorrect vessel. Similarly the merchant and the ecommerce platform may be informed about events of interest pertaining to the ecommerce shipment status.

There is therefore a clear need to be able to inform customers of events of interest of their ecommerce products' shipment process.

### SUMMARY

This document describes a system for allowing ecommerce merchants to keep their customers informed about a purchased product's shipment progress based on networking factors of the shipment. When determining what information to provide to customers, the networking factors can be used independently or in combination with matching of additional information sources. A tracking device coupled to the customer's shipment may obtain information about available networks. Merchants may indicate that events of interest be triggered for customers whose shipments' network conditions meet certain criteria and how such events should be provided to the customer. For example, events of interest for a shipment approaching its destination can be provided to B2C ecommerce customers (whose delivery expectations are focused on speed) while events of interest fora shipment determined to arrive later than planned can be provided to B2B ecommerce customers (deliveries focused on punctuality).

In general, in one aspect, information about a network condition of a remote computing device coupled to an ecommerce shipment on its way from a remote merchant to a remote customer and which is accessing a first network is received at a server, the network conditions of the ecommerce shipment are recorded, an event of interest is identified at the server based on the network conditions, the event of interest is provided to the customer through a second network, and the event of interest is provided to the merchant through a third network.

Implementations may include one or more of the following features. The first network can include a mobile phone network having base stations. The network conditions can include at least one of available base stations and their associated signal strength, available wireless networks and their associated signal strength, available LPWAN networks and their associated signal strength, available bluetooth devices, available bluetooth low energy devices, and available iBeacons. The remote computing device can include a mobile phone, an asset tracker, or an IoT tracker. The remote computing device can be shared by a plurality of ecommerce shipments. Coupling of the remote computing device to the ecommerce shipment can include associating an identifier of the remote computing device with an identifier of the ecommerce shipment and storing said association in a database or a data file. The identifier of the remote computing device can include an IMEI, IMSI, Serial Number, or any other manufacturer designation. The identifier of the ecommerce shipment can include the ecommerce order number, a tracking number generated by the ecommerce platform through which the product was purchased, an AWB number, a BoL number, or any other unique designation.

At the server, recording of the ecommerce shipment's network conditions can include at least one of storing in a database or a datafile. The event of interest can be identified from among a plurality of events of interest by matching parameters associated with the event of interest, with the information inferred from the network conditions of the ecommerce shipment. The information inferred from the network conditions of the ecommerce shipment can include at least one of geographical location, geographical location type, transport conditions, and transport on which the ecommerce shipment is loaded.

Determining the geographical location of the remote computing device can include at least one of identifying the approximate geographical location of the remote computing device based on signal triangulation using the network conditions received at the server, and identifying the country of the remote computing device based on the country code of the base station serving the remote computing device.

The geographical location type can include at least one of urban and rural. Determining whether the ecommerce shipment is in an urban area can include detecting the presence of at least a predetermined number of network signals of each predetermined network type, each with a network signal stronger than a predetermined signal level within the network conditions of the remote computing device. Determining whether the ecommerce shipment is in a rural area can include detecting the presence of at least a predetermined number of network signals of each predetermined network type, each with a network signal stronger than a predetermined signal level, but not more than a second predetermined number of network signals of each predetermined network type within the network conditions of the remote computing device.

The transport condition location of the ecommerce shipment can include at least one of on board a transport, not on board a transport, within a shipping container, and not within a shipping container.

Determining whether the ecommerce shipment is on board a transport can include detecting when the network conditions of the remote computing device continuously or intermittently include a recurring network signal while the shipment travels more than a predetermined distance away from the initial location at which the recurring network's signal was first reported and when the recurring network's signal strength does not go below a predetermined minimal signal strength throughout the shipment traveling that distance. A network signal can be determined to be recurring by detecting an identifier such as a cell ID, an SSID, or MAC address belonging to the network. Determining the transport on which the ecommerce shipment is loaded can include looking up the recurring network identifier in a database of transport network identifiers.

Determining whether the ecommerce shipment is not on board a transport can include detecting when the network conditions of the remote computing device do not continuously or intermittently include a recurring network signal stronger than a predetermined signal level while the shipment travels more than a predetermined distance.

Determining whether the ecommerce shipment is within a shipping container can include detecting when the signal level of a predetermined percentage of the network signals indicated by the network conditions of the remote computing device drop below a predetermined signal level.

Determining whether the ecommerce shipment is not within a shipping container can include detecting when the signal level of a predetermined percentage of the network signals indicated by the network conditions of the remote computing device are above a predetermined signal level and more than a predetermined number of such network signals is present.

The event of interest can include at least one of shipment is on board a transport, shipment has been unloaded from a transport, shipment has been containerised, shipment has been de-containerised, shipment arrived at a previously unvisited country, shipment arrived at a different country, shipment is not moving, and shipment is en route.

Identifying the shipment is on board a transport event of interest can include detecting that the ecommerce shipment is on board a transport and when the ecommerce shipment was previously not on board a transport. Identifying the shipment has been unloaded from a transport event of interest can include detecting that the ecommerce shipment is not on board a transport and when the ecommerce shipment was previously on board a transport.

Identifying the shipment has been containerised event of interest can include detecting that the ecommerce shipment is within a container and when the ecommerce shipment was previously not within a container. Identifying the shipment has been de-containerised event of interest can include detecting that the ecommerce shipment is not within a container and when the ecommerce shipment was previously within a container.

Identifying the shipment arrived at a previously unvisited country event of interest can include detecting that the determined country of the ecommerce shipment differs from any previously determined country of the shipment.

Identifying the shipment arrived at a different country event of interest can include detecting that that determined country of the ecommerce shipment differs from the last previously determined country of the shipment.

The shipment is not moving event of interest can be associated with a predetermined amount of time and a predetermined distance. Identifying the shipment is not moving event of interest can include detecting when the total amount of time the ecommerce shipment has stayed within a geographical radius the size of the predetermined distance is equal to or greater than the predetermined amount of time.

The shipment is en route event of interest can be associated with a predetermined distance. Identifying the shipment is en route event of interest can include detecting that the ecommerce shipment's distance from its initial geographical location is equal to or greater than the predetermined distance.

The second network can include a mobile phone network having base stations, or an Internet Protocol (IP) network and providing the event of interest to the customer can be done by at least one of sending an email, sending a push notification, sending a text message, sending a multimedia message, sending a social media message, providing a website alert, presenting a web page, providing information through a mobile application, or sending a chatbot message.

The third network can include a mobile phone network having base stations, or an Internet Protocol (IP) network and providing the event of interest to the merchant can be done by at least one of sending an email, sending a push notification, sending a text message, sending a multimedia message, sending a social media message, providing a website alert, presenting a web page, providing information through a mobile application, or sending a chatbot message.

In general, in another aspect, information about a network condition of a remote computing device coupled to an ecommerce shipment on its way from a remote merchant to a remote customer and which is accessing a first network is received at a server, the network conditions of the ecommerce shipment are recorded, an event of interest is identified at the server based on the network conditions and information stored in a pre-established shipment route, the event of interest is provided to the customer through a second network, and the event of interest is provided to the merchant through a third network.

Implementations may include one or more of the following features. At the server, the event of interest can be identified from among a plurality of events of interest by matching parameters associated with the event of interest, with the information inferred from the network conditions of the ecommerce shipment, its previously determined locations, and the shipment's pre-established shipment route. The shipment's pre-established shipment route can be provided by at least one of an air waybill (AWB), a bill of lading (BoL), provisioning the planned route via a batch import operation, provisioning the planned route via an API, provisioning the planned route on a mobile application, and provisioning the planned route on a web interface. The event of interest can include at least one of shipment nearing its destination, shipment arrived at destination country, shipment has not yet arrived in destination country, shipment is going through heavy traffic, shipment is expected to experience delays due to a natural disaster, shipment off course, transport delayed in leaving port of call, shipment is on board the correct transport, and shipment is on board an incorrect transport.

The shipment nearing its destination event of interest can be associated with a predetermined distance. Identifying the shipment nearing its destination event of interest can include detecting when the ecommerce shipment's distance from its final destination provided in the shipment's pre-established shipment route is equal to or less than the predetermined distance. The shipment's final destination can include at least one of an address, geographical coordinates, and a zipcode.

Identifying the shipment arrived at destination country event of interest can include detecting when the determined country of the shipment is the same as the destination country provided in the shipment's pre-established shipment route.

The shipment has not yet arrived in destination country event of interest can be associated with a predetermined amount of time. Identifying the shipment has not yet arrived in destination country event of interest can include detecting when there is less than the predetermined amount of time left until the planned delivery time provided by the shipment's pre-established shipment route and the determined country of the shipment differs from the destination country provided in the shipment's pre-established shipment route. The planned delivery time can include at least one of a date, a date and a time, and a range of dates.

Traffic conditions of the shipment can be determined based on the determined location. The shipment is going through heavy traffic event of interest can be associated with a predetermined level of traffic congestion. Identifying the shipment is going through heavy traffic event of interest can include detecting when the determined traffic conditions of the shipment are greater than or equal to the predetermined level of traffic congestion.

Natural disasters in the general region of the ecommerce shipment can be determined based on the determined location. The shipment is expected to experience delays due to a natural disaster event of interest can be associated with a predetermined type of natural disaster and a predetermined severity level of the natural disaster. Identifying the shipment is expected to experience delays due to a natural disaster event of interest can include detecting when the type of the determined natural disaster in the general region of the ecommerce shipment matches the predetermined type of natural disaster and the severity level of the determined natural disaster in the general region of the shipment is greater than or equal to the predetermined severity level of the natural disaster. Natural disasters can include avalanches, landslides, earthquakes, sinkholes, volcanic eruptions, floods, tsunami, wildfires, tornadoes, hurricanes, tropical storms and other severe storms. The severity level of the natural disaster can be provided as an earthquake magnitude, flood stage, storm danger level, volcanic alert level, avalanche risk level, and a boolean indication of the existence of the natural disaster.

The location of the ecommerce shipment's current transport vessel can be determined based on the pre-established shipment route. The shipment off course event of interest can be associated with a predetermined distance. Identifying the shipment off course event of interest can include detecting when the distance between the determined shipment location and the determined transport vessel location is equal to or greater than the predetermined distance. The transport vessel can include at least one of a train, a freight train, a truck, an airplane, a helicopter, a delivery drone, and a maritime cargo vessel.

The transport delayed in leaving port of call event of interest can be associated with a predetermined amount of time and a predetermined distance. Identifying the transport delayed in leaving port of call event of interest can include detecting when more than the predetermined amount of time has passed since the transport on which the shipment was supposed to be loaded on was planned to depart from its current station or port of call and the distance between the determined location of the shipment and the location of the port of call or station is less than or equal to the predetermined distance. Determining which transport the shipment was supposed to be loaded on and its planned departure time can be done by using the pre-established shipment route.

Identifying the shipment is on board the correct transport event of interest can include detecting when the shipment's determined transport matches the transport provided in the shipment's pre-established shipment route. Similarly, identifying the shipment is on board an incorrect transport event of interest can include detecting when the shipment's determined transport differs from the transport provided in the shipment's pre-established shipment route.

In general, in another aspect, a computer-implemented method includes enabling merchants to associate events of interest with one or more network conditions, geographical location information, and other parameters to allow events of interest to be provided to customers whose ecommerce shipments' network conditions and inferred conditions match the network conditions, geographical location information and other parameters associated with the event of interest.

Implementations may include one or more of the following features. The method can include providing a user interface to allow the merchant to associate the event of interest with network conditions, geographical location information, or other parameters.

In general, in one aspect, an apparatus includes a storage device to store events of interest each associated with a network condition; and a server to receive information about a network condition of a remote computing device coupled to an ecommerce shipment on its way from a remote merchant to a remote customer and which is accessing a first network, record the network conditions of the ecommerce shipment, identify an event of interest based on the network conditions, provide the event of interest to the customer through a second network, and provide the event of interest to the merchant through a third network.

Implementations may include one or more of the following features. The server can identify the event of interest from among a plurality of events of interest by matching parameters associated with the event of interest to the network conditions of the ecommerce shipment and information inferred from them. The server can identify a geographical location of the ecommerce shipment based on the network conditions and receive information about traffic conditions and natural disasters that may affect the shipment. The server can identify a transport condition of the ecommerce shipment (for example whether the shipment is loaded on a transport, whether the shipment is loaded on a specific transport) based on the network conditions and receive information about transport conditions affecting the ecommerce shipment.

In general, in another aspect, an apparatus includes a graphical user interface to enable merchants to associate events of interest with one or more network conditions, geographical location information, and other parameters to allow events of interest to be provided to customers whose ecommerce shipments' network conditions and inferred conditions match the network conditions, geographical location information and other parameters associated with the event of interest.

Implementations may include one or more of the following features. The network condition includes available base stations and their associated signal strength, available wireless networks and their associated signal strength, available LPWAN networks and their associated signal strength, available bluetooth devices, available bluetooth low energy devices, and/or available iBeacons.

In general, in another aspect, an apparatus includes a device having a network interface to access a network. The device is configured to provide the network information to a remote server.

Implementations may include one or more of the following features. The network interface can include a wireless network interface, an LPWAN network interface, a cellular network interface, a Bluetooth network interface, or a bluetooth low energy network interface. The device can include a mobile phone, an asset tracker, or an IoT tracker.

In general, in one aspect, a system includes means for receiving information about a network condition of a remote computing device coupled to an ecommerce shipment on its way from a remote merchant to a remote customer and which is accessing a first network, means of identifying an event of interest based on the network conditions, means of providing the event of interest to the customer through a second network; and means of providing the event of interest to the merchant through a third network.

These and other aspects and features, and combinations of them, may be expressed as methods, apparatus, systems, means for performing functions, program products, and in other ways.

The systems and methods disclosed herein may have one or more of the following advantages. By providing events of interest that are selected based in part on network conditions, more relevant alerts may be provided to customers and merchants, providing a better user experience. By relying on the network conditions instead of on dedicated hardware the computing device can be simpler to design and manufacture, have a reduced form factor, be cheaper to maintain, function for longer periods of time and provide minimal interruptions in the continuity of the information it provides.

The details of one or more embodiments are set forth in the accompanying drawings and the description below. Other features, objects, and advantages of the invention will be apparent from the description and drawings, and from the claims.

### DESCRIPTION OF DRAWINGS

FIG. 1 is a schematic diagram of an information retrieval system.

FIG. 2 is a diagram of a graphical user interface.

FIGS. 3 to 5 are flow diagrams of processes.

FIG. 6 is a schematic diagram of a general computing system.

Like reference symbols in the various drawings indicate like elements.

### DETAILED DESCRIPTION

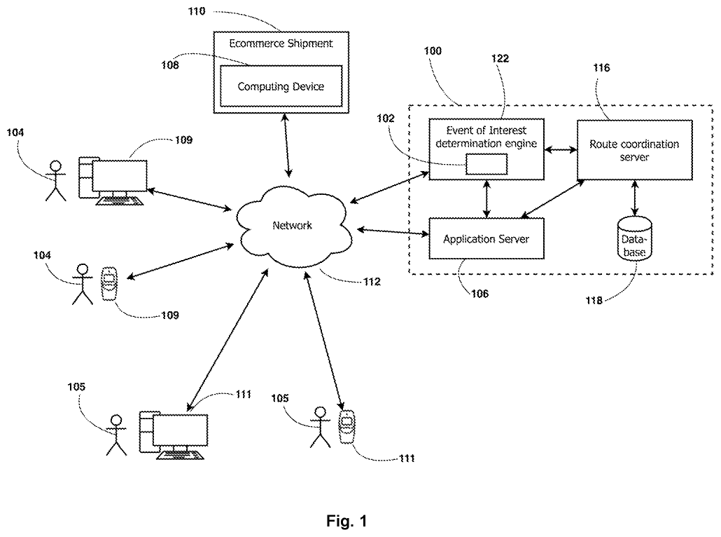

Referring to FIG. 1, an exemplary ecommerce information retrieval system 100 retrieves and provides information (e.g., web documents) and content 102 (e.g. events of interest) that match queries submitted by remote customers 104 and merchants 105. The system 100 includes an application server 106 that enables the customers 104 and the merchants 105 to retrieve information using, for example a shipment identifier or an order identifier. The system 100 is configured to receive information about network conditions of the ecommerce shipment 110, use the network conditions as one of the criteria for identifying events of interest 102, and provide the events of interest to the customers 104 and to the merchants 105. By using network conditions of the ecommerce shipment 110 as one of the criteria for selecting events of interest 102, more relevant events of interest 102 can be served to customers 104 and to merchants 105.

The ecommerce shipment 110 is coupled to a computing device 108 (e.g., mobile phone, asset tracker, IoT tracker) which accesses the application server 106 through a network 112 (e.g., Internet). The computing device 108 provides information about its network conditions. The computing device 108 may be configured to provide information about, for example, available base stations and their associated signal strength, available wireless networks and their associated signal strength, available LPWAN networks and their associated signal strength, available bluetooth devices, available bluetooth low energy devices, and available iBeacons.

The computing device 108 is configured to periodically transmit information to the application server 106. When the computing device 108 accesses the application server 106 to provide or retrieve information, the computing device 108 sends a request that includes information about its network conditions to the application server 106. In response, the application server 106 returns a document (e.g. a JSON configuration file) generated as a result of the request submitted by the computing device 108. The application server 106 may also cause events of interest 102 to be provided to the recipient of the ecommerce shipment (the customer 104) and/or the sender of the ecommerce shipment (the merchant 105). The events of interest 102 may be provided by an event of interest determination engine 122 that selects the events of interest 102 based on the customer 104, the merchant 105, and the network conditions provided by the computing device 108.

The application server 106 sends the information about the network conditions of the remote computing device 108 to the event of interest determination engine 122. The event of interest determination engine 122 identifies events of interest 102 based on several criteria. One criterion is the transport condition of the ecommerce shipment 110 (for example is it within a shipping container or not, whether it is on board a transport or not, etc). Another criterion is which specific transport the ecommerce shipment 110 is loaded on. Another criterion is the geographical location of the ecommerce shipment 110. Yet another criterion is the geographical location type of the ecommerce shipment 110. The event of interest determination engine 122 selects all events of interest 102 matching the criteria specified above and sends them to the application server 106. The application server 106 provides the events of interest to the customer 104 and the merchant 105.

When merchants 105 provision the events of interest 102 on the system 100, the merchants 105 may specify the parameters that are associated to the events of interest 102. For example, a merchant 105 shipping an ecommerce shipment 110 to a B2B customer 104 may specify that an event of interest 102 should be triggered if the shipment is determined to arrive later than planned (as B2B shipments tend to focus on punctuality). Similarly, a merchant 105 shipping an ecommerce shipment 110 to a B2C customer 104 may specify that an event of interest 102 should be triggered if the shipment is approaching its destination (as B2C shipments tend to focus on speed).

The system 100 includes a route coordination server 116 that determines general route information of the ecommerce shipment 110 based on the network conditions of the computing device 108 and, optionally, on information about the pre-planned route of the ecommerce shipment 110. For example, the route coordination server 116 can be used to determine the location information of the ecommerce shipment 110. Location information can be inferred by cellular network signal triangulation. Alternatively, the route coordination server 116 may be able to infer the location of the ecommerce shipment 110 based on Internet Protocol (IP) address of the computing device 108. Using the database 118, the route coordination server 116 records the network conditions of the computing device 108, the determined geographical location of the ecommerce shipment 110, the determined transport condition of the ecommerce shipment 110 and may provide these recorded data when requested. The route coordination server 116 can be used to determine the planned route information of the ecommerce shipment 110 based on the shipment's air waybill, bill of lading, or route information provisioned via an API, batch provisioning call, mobile application, or web interface. The route information includes at least one of the pickup location, the pickup time, the delivery location, the delivery time, one or more stops along the way, one or more specific routes, and one or more transports used to deliver the shipment with their departure and arrival times.

A feature of the system 100 is that it can provide events of interest that are configured for individual customers 104 and/or their ecommerce shipments 110 based on geographical locations or transport conditions inferred from the networking conditions of the individual ecommerce shipments 110.

The system 100 includes an event of interest determination engine 122 that determines whether an event of interest 102 should be provided to the customer 104 and to the merchant 105 for each ecommerce shipment 110 based on information obtained from the route coordination server 116.

In some examples, route information obtained from the route coordination server 116 can be used to infer that the ecommerce shipment 110 has arrived at a previously unvisited country and provide an event of interest 102 to the customer 104 and to the merchant 105. For example, if the information provided by the route coordination server 116 indicates that the ecommerce shipment 110 is currently in France, and further indicates that on its previous communications with the system 100 the computing device 108 was not in France then the shipment arrived at a previously unvisited country event of interest 102 may be triggered and the application server can provide it to the customer 104 and to the merchant 105.

In some examples, route information obtained from the route coordination server 116 can be used to infer that the ecommerce shipment 110 has arrived at a different country and provide an event of interest 102 to the customer 104 and to the merchant 105. For example, if the information provided by the route coordination server 116 indicates that the ecommerce shipment 110 is currently in France, and further indicates that on its previous communication with the system 100 the computing device 108 was in Spain then the shipment arrived at a new country event of interest 102 may be triggered and the application server can provide it to the customer 104 and to the merchant 105.

In some examples, route information obtained from the route coordination server 116 can be used to infer that the ecommerce shipment 110 has not moved for a while and provide an event of interest 102 to the customer 104 and to the merchant 105. For example, if the information provided by the route coordination server 116 indicates that the ecommerce shipment 110 has remained within an event of interest's 102 associated distance for the event of interest's 102 associated amount of time then the shipment is not moving event of interest 102 may be triggered and the application server 106 can provide it to the customer 104 and to the merchant 105.

In some examples, route information obtained from the route coordination server 116 can be used to infer that the ecommerce shipment 110 is en route from the merchant 105 to the customer 104 and an event of interest 102 be provided to the customer 104 and to the merchant 105. For example, if the information provided by the route coordination server 116 indicates that the ecommerce shipment 110 has moved beyond an event of interest's 102 associated predetermined distance from the first location recorded and provided by the route coordination server 116 then the shipment is en route event of interest 102 may be triggered and the application server 106 can provide it to the customer 104 and to the merchant 105.

In some examples, route information obtained from the route coordination server 116 can be used to infer that the ecommerce shipment 110 is on board a transport and an event of interest be provided to the customer 104 and to the merchant 105. For example, if the route information provided by the route coordination server 116 indicates that the network conditions of the computing device 108 continuously or intermittently include a specific network signal while the ecommerce shipment 110 travels more than an event of interest's 102 associated predetermined distance away from the initial location at which the network signal was first reported and when the network signal strength does not go below the event of interest's 102 associated predetermined minimal signal strength throughout the ecommerce shipment 110 traveling that distance then the shipment is on board a transport event of interest 102 may be triggered and the application server 106 can provide it to the customer 104 and to the merchant 105. The route coordination server 116 can further be queried by the event of interest determination engine 122 to determine the specific transport on which the ecommerce shipment 110 is loaded. The route coordination server 116 may do so, for example, by looking up an identifier such as a cell ID, an SSID, or MAC address belonging to the network in the database 118. This information may also be provided as part of the event of interest 102 by the application server 106 to the customer 104 and to the merchant 105.

In some examples, route information obtained from the route coordination server 116 can be used to infer that the ecommerce shipment 110 has been unloaded from a transport and an event of interest be provided to the customer 104 and to the merchant 105. For example, if the route information provided by the route coordination server 116 indicates that the network conditions of the computing device 108 do not continuously or intermittently include a recurring network signal stronger than an event of interest's 102 associated signal level while the ecommerce shipment 110 travels more than the event of interest's 102 associated distance, and the ecommerce shipment 110 has previously been determined to be on board a transport then the shipment has been unloaded from a transport event of interest 102 may be triggered and the application server 106 can provide it to the customer 104 and to the merchant 105.

In some examples, route information obtained from the route coordination server 116 can be used to infer that the ecommerce shipment 110 has been containerised and an event of interest be provided to the customer 104 and to the merchant 105. For example, if the route information provided by the route coordination server 116 indicates that the signal level of an event of interest's 102 associated percentage of the network signals indicated by the network conditions of the remote computing device 108 drop below the event of interest's 102 associated signal level then the shipment has been containerised event of interest 102 may be triggered and the application server 106 can provide it to the customer 104 and to the merchant 105.

In some examples, route information obtained from the route coordination server 116 can be used to infer that the ecommerce shipment 110 has been de-containerised and an event of interest 102 be provided to the customer 104 and to the merchant 105. For example, if the route information provided by the route coordination server 116 indicates that the signal level of an event of interest's 102 associated percentage of the network signals indicated by the network conditions of the remote computing device 108 are above the event of interest's 102 associated signal level and more than the event of interest's 102 associated number of such network signals is present, and the ecommerce shipment 110 has previously been determined to be in a shipping container then the shipment has been de-containerised event of interest 102 may be triggered and the application server 106 can provide it to the customer 104 and to the merchant 105.

In some examples, route information obtained from the route coordination server 116 can be used to infer whether the ecommerce shipment 110 is nearing its destination or whether it is expected to be late in arriving there without using information from external services and provide an event of interest 102 to the customer 104 and the merchant 105. For example, if the information obtained from the route coordination server 116 indicates that the ecommerce shipment 110 is within an event of interest's associated predetermined distance from the ecommerce shipment's 110 destination the shipment is nearing its destination event of interest 102 may be triggered and the application server 106 may provide it to the customer 104 and to the merchant. In another example, if the ecommerce shipment 110 is indicated by the information obtained from the route coordination server 116 as having arrived at its destination country the shipment arrived at destination country event of interest 102 may be triggered and the application server 106 can provide it to the customer 104 and to the merchant 105. In another example, if the information provided by the route coordination server 116 indicates that the ecommerce shipment has not arrived in its destination country within an event of interest's associated predetermined amount of time prior to the ecommerce shipment's 110 planned delivery date and time the shipment has not yet arrived in destination country event of interest 102 may be triggered and the application server 106 can provide it to the customer 104 and to the merchant 105.

The event of interest determination engine 122 may also access, through the network 112, services that provide information about general environmental and transport conditions at the geographical region where the ecommerce shipment 110 is located or for the transport on which the ecommerce shipment 110 is loaded. The event of interest determination engine 122 may access a traffic service, a natural disaster service, marine traffic service, train traffic service, truck tracking service, and airline traffic service, to obtain information about local traffic conditions, natural disasters, planned and actual marine vessel routes, departures, arrivals, and locations, planned and actual flight routes, departures, arrivals, and locations, planned and actual train routes, departure, arrivals, and locations, and planned and actual truck routes, departures, arrivals and locations.

In some examples, route information obtained from the route coordination server 116 can be used to infer that the transport that the ecommerce shipment 110 is loaded on is waiting in a traffic jam. For example, if the information retrieved from the route coordination server 116 indicates that the ecommerce shipment 110 is traveling on a highway and moving slower than an event of interest's 102 associated predetermined speed the shipment is going through heavy traffic event of interest 102 may be triggered and the application server 106 can provide it to the customer 104 and to the merchant 105. Alternatively, the event of interest determination engine 122 may access, through the network 112, a traffic service to determine the traffic conditions in the area of the ecommerce shipment 110. If the indicated traffic conditions exceed an event of interest's 102 associated predetermined traffic conditions level then the shipment going through heavy traffic event of interest 102 may be triggered and the application server 106 can provide it to the customer 104 and to the merchant 105.

In some examples, route information obtained from the route coordination server 116 can be used to infer that a natural disaster has recently occurred in the geographical region where the ecommerce shipment 110 is currently located by accessing a natural disaster service through the network 112. An event of interest 102 about expected delays due to the natural disaster may be provided to the customer 104 and to the merchant 105. For example, the geographical location indicated by the route coordination server 116 may be used to retrieve information about natural disasters in the geographical region where the ecommerce shipment 110 is located. If it is inferred from the retrieved natural disaster information that an earthquake has recently occurred in the geographical region where the ecommerce shipment 110 is located and that the earthquake is of a greater severity than that of an event of interest's 102 associated predetermined severity level than the shipment is expected to experience delays due to a natural disaster event of interest 102 may be triggered and the application server 106 can provide it to the customer 104 and to the merchant 105.

In some examples, route information obtained from the route coordination server 116 can be used to infer whether the ecommerce shipment 110 is on board the transport it was supposed to be loaded on according to the planned shipment route of the ecommerce shipment 110. For example, if the planned shipment route indicates that the ecommerce shipment 110 is planned to be on board a specific marine vessel and the information obtained from the route coordination server 116 indicates that the ecommerce shipment 110 is on board a different vessel a shipment is on board the incorrect transport event of interest 102 may be provided to the customer 104 and to the merchant 105. Similarly, if the planned shipment route indicates that the ecommerce shipment 110 is planned to be on board a specific marine vessel and the information obtained from the route coordination server 116 indicates that the ecommerce shipment 110 is indeed on board the same vessel a shipment is on board the correct transport event of interest 102 may be provided to the customer 104 and to the merchant 105.

In some examples, route information obtained from the route coordination server 116 can be used to infer whether the ecommerce shipment 110 is off course. For example, if the information retrieved from the route coordination server 116 indicates that the distance between the location of the ecommerce shipment 110 and the location of the transport vessel on which it is supposed to be loaded on is greater than an event of interest's 102 associated predetermined distance then the shipment off course event of interest 102 may be triggered and the application server 106 can provide it to the customer 104 and to the merchant 105.

In some examples, route information obtained from the route coordination server 116 can be used to infer whether the transport on which the ecommerce shipment 110 is supposed to be loaded on is delayed in leaving its port of call. For example, if the information obtained from the route coordination server 116 indicates that more than an event of interest's 102 associated predetermined amount of time has passed since the transport on which the ecommerce shipment 110 was supposed to be loaded on was planned to depart from its current station or port of call and the distance between the ecommerce shipment's 110 location and the location of the port of call or station is less than or equal to the event of interest's 102 associated predetermined distance then the transport delayed in leaving port of call event of interest 102 may be triggered and the application server 106 can provide it to the customer 104 and to the merchant 105.

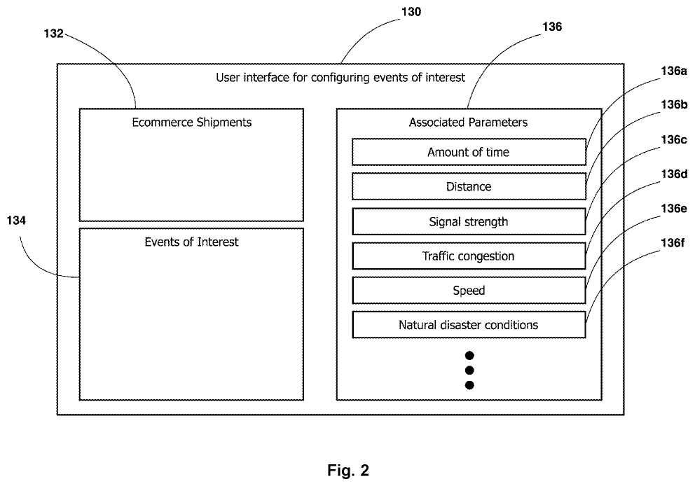

Referring to FIG. 2, an exemplary graphical user interface (GUI) 130 is provided to allow a merchant 105 (FIG. 1) to configure parameters associated with an event of interest 102 (FIG. 1) for a selected ecommerce shipment 110 (FIG. 1). The GUI 130 includes an area 132 for selecting the ecommerce shipment for which to configure the event of interest 102, an area 134 for selecting the event of interest 102, and an area 136 for specifying the parameters associated with the event of interest. The area 136 includes areas 136a, 136b, 136c, 136d, 136e, 136f for specifying amount of time, distance, signal strength, traffic congestion, speed, and natural disaster conditions respectively. The GUI 130 can be used to configure other parameters associated with the event of interest 102.

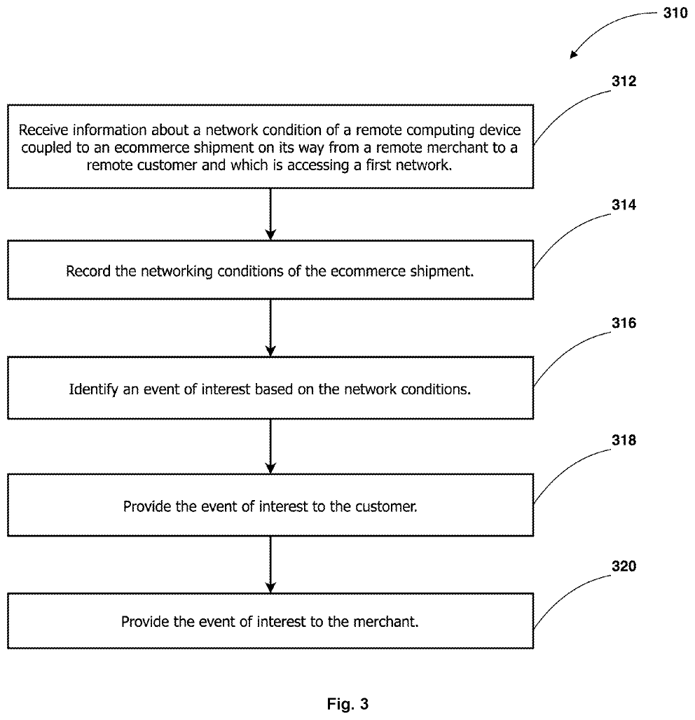

Referring to FIG. 3, an exemplary process 310 can be used for providing events of interest for ecommerce shipments based on network conditions. The process 310 receives information about a network condition of a remote computing device coupled to an ecommerce shipment on its way from a remote merchant to a remote customer and which is accessing a first network (312). For example, the information can be generated by the remote computing device 108 (FIG. 1) and received by the application server 106 (FIG. 1). The ecommerce shipment to which the remote computing device 108 is coupled can be the ecommerce shipment 110 (FIG. 1) on its way from the merchant 105 (FIG. 1) to the customer 104 (FIG. 1). The first network can be the network 112 (FIG. 1).

The process 310 records the networking conditions of the ecommerce shipment (314). For example, the route coordination server 116 (FIG. 1) can record the networking conditions of the ecommerce shipment 110 in the database 118 (FIG. 1).

The process 310 identifies an event of interest based on the network conditions (316). For example, the event of interest determination engine 122 (FIG. 1) may identify the event of interest 102 (FIG. 1). The process 310 provides the event of interest to the customer (318). For example, the system 100 can provide the event of interest 102 to the customer 104 through the network 112. The process 310 provides the event of interest to the merchant (320). For example, the system 100 can provide the event of interest 102 to the merchant 105 through the network 112.

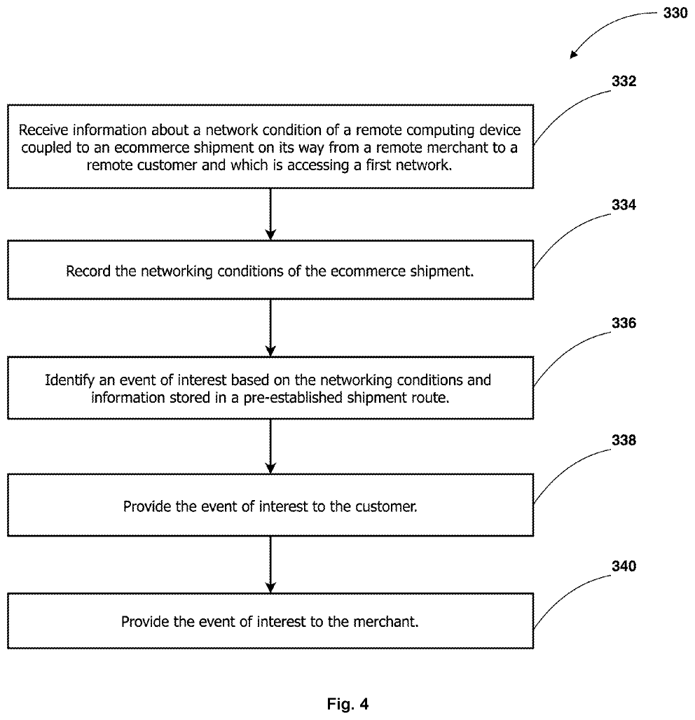

Referring to FIG. 4, an exemplary process 330 can be used for providing events of interest for ecommerce shipments based on network conditions. The process 330 receives information about a network condition of a remote computing device coupled to an ecommerce shipment on its way from a remote merchant to a remote customer and which is accessing a first network (332). For example, the information can be generated by the remote computing device 108 (FIG. 1) and received by the application server 106 (FIG. 1). The ecommerce shipment to which the remote computing device 108 is coupled can be the ecommerce shipment 110 (FIG. 1) on its way from the merchant 105 (FIG. 1) to the customer 104 (FIG. 1). The first network can be the network 112 (FIG. 1).

The process 330 records the networking conditions of the ecommerce shipment (334). For example, the route coordination server 116 (FIG. 1) can record the determined geographical location of the ecommerce shipment 110 (FIG. 1) in the database 118 (FIG. 1).

The process 330 identifies an event of interest based on the networking conditions and information stored in a pre-established shipment route (336). For example, the route coordination server 116 can retrieve the pre-established shipment route from the database 118. The event of interest determination engine 122 (FIG. 1) may identify the event of interest 102 (FIG. 1).

The process 330 provides the event of interest to the customer (338). For example, the system 100 can provide the event of interest 102 to the customer 104 through the network 112. The process 330 provides the event of interest to the merchant (340). For example, the system 100 can provide the event of interest 102 to the merchant 105 through the network 112.

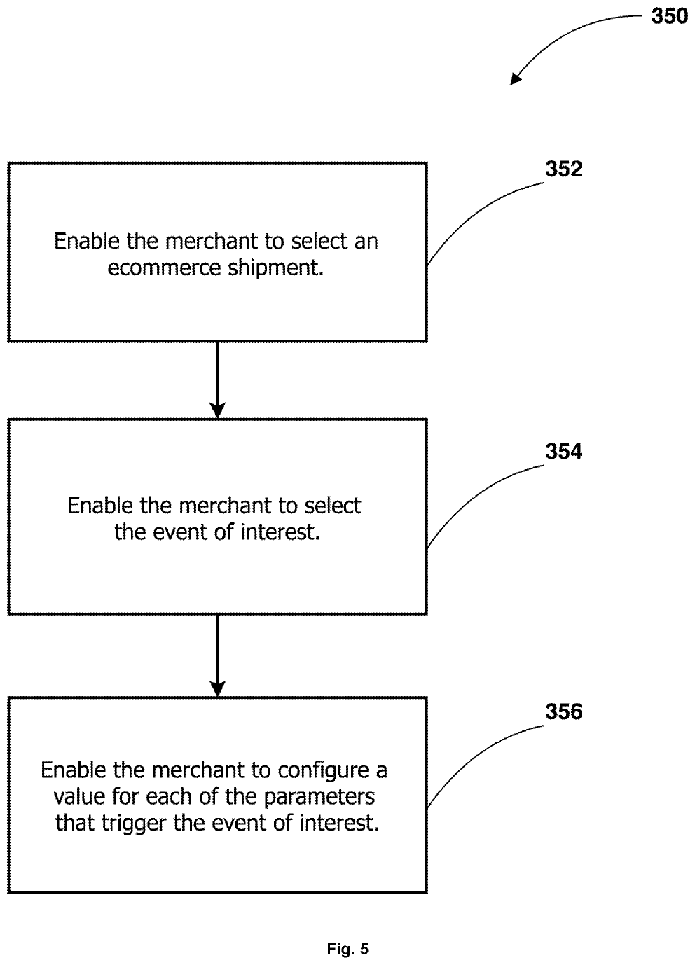

Referring to FIG. 5, an exemplary process 350 can be used to associate ecommerce shipments with events of interest, and associate the events of interest with one or more parameters to allow the events of interest to be provided to customers whose ecommerce shipment's network conditions indicate parameters that match the parameters associated with the events of interest. The process 350 enables the merchant to select an ecommerce shipment (352), enables the merchant to select an event of interest (354), and enable the merchant to configure a value for each of the parameters that trigger the event of interest (356).

For example, a user interface can be provided to allow the merchant 105 to associate an ecommerce shipment with an event of interest. The user interface can be configured to allow the merchant 105 to configure the values of the various parameters associated with the event of interest. The parameters associated with the event of interest can include, for example, at least one of amount of time, distance, signal strength, traffic congestion, speed, and natural disaster conditions.

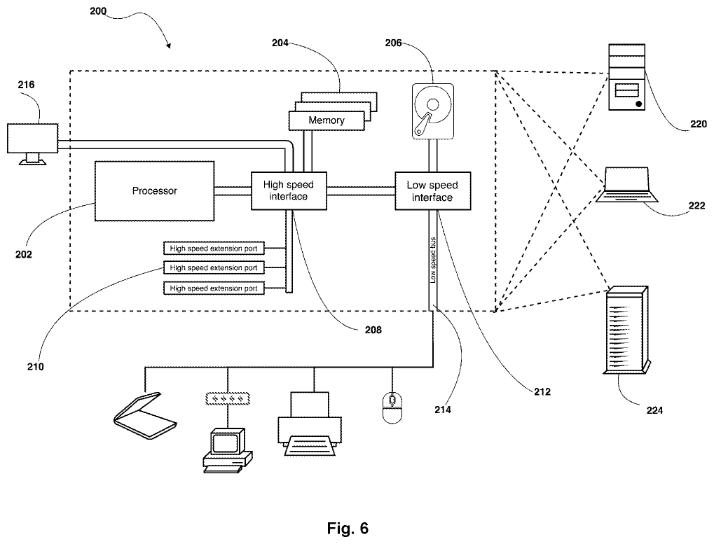

FIG. 6 shows a schematic representation of a general computing system 200 that can be used to implement the system 100 or a component of the system 100, such as the route coordination server 116, event of interest determination engine 102 or application server 106. Computing device 200 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 200 includes a processor 202, memory 204, a storage device 206, a high-speed interface 208 connecting to memory 204 and high-speed expansion ports 210, and a low speed interface 212 connecting to low speed bus 214 and storage device 206. Each of the components 202, 204, 206, 208, 210, and 212, are interconnected using various busses, and may be mounted on a common motherboard or in other manners as appropriate. The processor 202 can process instructions for execution within the computing device 200, including instructions stored in the memory 204 or on the storage device 206 to display graphical information for a GUI on an external input/output device, such as display 216 coupled to high speed interface 208. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

The memory 204 stores information within the computing device 200. In one implementation, the memory 204 is a volatile memory unit or units. In another implementation, the memory 204 is a non-volatile memory unit or units. The memory 204 may also be another form of computer-readable medium, such as a magnetic or optical disk.

The storage device 206 is capable of providing mass storage for the computing device 200. In one implementation, the storage device 206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 204, the storage device 206, memory on processor 202, or a propagated signal.

The high speed controller 208 manages bandwidth-intensive operations for the computing device 200, while the low speed controller 212 manages lower bandwidth-intensive operations. Such allocation of functions is exemplary only. In one implementation, the high-speed controller 208 is coupled to memory 204, display 216 (e.g., through a graphics processor or accelerator), and to high-speed expansion ports 210, which may accept various expansion cards (not shown). In the implementation, low-speed controller 212 is coupled to storage device 206 and low-speed expansion port 214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 200 may be implemented in a number of different forms, as shown in the figure. For example, it may be implemented as a standard server 220, or multiple times in a group of such servers. It may also be implemented as part of a rack server system 224. In addition, it may be implemented in a personal computer such as a laptop computer 222. Each of such devices (e.g., standard server, rack server system, personal computer, laptop computer) may contain one or more of computing device 200, and an entire system may be made up of multiple computing devices 200 communicating with each other.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse, trackball, touch-sensitive screen, or iDrive-like component) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications and methods have been described, it should be recognized that numerous other applications are contemplated.

User interfaces different from those described above can be used. The network 112 can be a local area network (LAN), a wide area network (WAN), any other type of network, or any combination of types of networks. The server 106, server 116, event of interest determination engine 122, and index 118 may be integrated into a single device.

In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A computer-implemented method comprising: receiving, from a computing device coupled to an ecommerce shipment on its way from a remote merchant to a remote customer, a request comprising information about one or more network conditions of the computing device; parsing the request; selecting from the request based on parsing, the information about the one or more network conditions; recording the information about the one or more network conditions; identifying an event of interest from a plurality of events of interest based on the one or more network conditions; providing the identified event of interest to the remote customer; and providing the identified event of interest to the remote merchant.

2. The computer-implemented method of claim 1, wherein the computing device comprises an IoT tracker.

3. The computer-implemented method of claim 1, wherein the computing device comprises one or more of an asset tracker, IoT tracker, or mobile phone.

4. The computer-implemented method of claim 1, wherein the one or more network conditions comprise at least one of available base stations and their associated signal strength, available wireless networks and their associated signal strength, available LPWAN networks and their associated signal strength, available bluetooth devices, available bluetooth low energy devices, and available iBeacons.

5. The computer-implemented method of claim 1, wherein identifying the event of interest is based on the inferred geographical location of the computing device.

6. The computer-implemented method of claim 5, wherein inferring the geographical location of the computing device comprises at least one of identifying the approximate geographical location of the remote computing device based on signal triangulation using the one or more network conditions, and identifying the country of the remote computing device based on the mobile country code of the base station serving the remote computing device as indicated by the one or more network conditions.

7. The computer-implemented method of claim 1, wherein identifying the event of interest is based on the inferred transport conditions of the computing device.

8. The computer-implemented method of claim 7, wherein the inferred transport conditions of the computing device comprise at least one of on board a transport vessel, not on board a transport vessel, within a shipping container, and not within a shipping container.

9. The computer-implemented method of claim 8, wherein the transport vessel comprises at least one of a train, a freight train, a truck, an airplane, a helicopter, a delivery drone, and a maritime cargo vessel.

10. The computer-implemented method of claim 8, wherein inferring the on board a transport vessel transport condition comprises identifying when the network conditions of the remote computing device include a recurring network signal while the computing device travels more than a predetermined distance away from the initial location at which the recurring network's signal was first reported; and when the recurring network's signal strength does not go below a predetermined minimal signal strength throughout the computing device traveling that distance.

11. The computer-implemented method of claim 10, wherein determining a network signal to be recurring comprises at least one of detecting a recurring cell ID, detecting a recurring SSID, or detecting a recurring MAC address.

12. The computer-implemented method of claim 1, wherein the event of interest comprises at least one of shipment is on board a transport vessel, shipment has been unloaded from a transport vessel, shipment has been containerised, shipment has been de-containerised, shipment arrived at a previously unvisited country, shipment arrived at a different country, shipment is not moving, and shipment is en route.

13. The computer-implemented method of claim 1, wherein the event of interest is identified further based on information stored in a pre-established shipment route of the ecommerce shipment.

14. The computer-implemented method of claim 13, wherein the event of interest comprises at least one of shipment nearing its destination, shipment arrived at destination country, shipment has not yet arrived in destination country, shipment is going through heavy traffic, shipment is expected to experience delays due to a natural disaster, shipment off course, shipment's transport vessel delayed in leaving port of call, shipment is on board the correct transport vessel, and shipment is on board an incorrect transport vessel.

15. An apparatus comprising: one or more processing devices; and one or more machine-readable media configured to store instructions that are executable by the one or more processing devices to perform operations comprising: receiving, from a computing device coupled to an ecommerce shipment on its way from a remote merchant to a remote customer, a request comprising information about one or more network conditions of the computing device; parsing the request; selecting, from the request based on parsing, the information about the one or more network conditions; recording the information about the one or more network conditions; identifying an event of interest from a plurality of events of interest based on the network conditions; providing the identified event of interest to the remote customer; and providing the identified event of interest to the remote merchant.

16. The apparatus of claim 15, wherein the computing device comprises one or more of an asset tracker, IoT tracker, or mobile phone.

17. The apparatus of claim 15, wherein the one or more network conditions comprise at least one of available base stations and their associated signal strength, available wireless networks and their associated signal strength, available LPWAN networks and their associated signal strength, available bluetooth devices, available bluetooth low energy devices, and available iBeacons.

18. One or more machine-readable media configured to store instructions that are executable by one or more processing devices to perform operations comprising: receiving, from a computing device coupled to an ecommerce shipment on its way from a remote merchant to a remote customer, a request comprising information about one or more network conditions of the computing device; parsing the request; selecting, from the request based on parsing, the information about the one or more network conditions; recording the information about the one or more network conditions; identifying an event of interest from a plurality of events of interest based on the network conditions; providing the identified event of interest to the remote customer; and providing the identified event of interest to the remote merchant.

19. The one or more machine-readable media of claim 18, wherein the computing device comprises one or more of an asset tracker, IoT tracker, or mobile phone.

20. The one or more machine-readable media of claim 18, wherein the one or more network conditions comprise at least one of available base stations and their associated signal strength, available wireless networks and their associated signal strength, available LPWAN networks and their associated signal strength, available bluetooth devices, available bluetooth low energy devices, and available iBeacons.
